(19) United States
(12) Patent Application Publication
(10) Pub. No.: US 2026/0163067 A1
(43) Pub. Date: Jun. 11, 2026

(54) RECHARGEABLE BATTERY WITH HIGH COMPRESSION ELECTRODE COIL AND METHODS FOR MAKING THE SAME

(71) Applicant: Medtronic, Inc., Minneapolis, MN (US)

(72) Inventor: Christian S. Nielsen, River Falls, WI (US)

(21) Appl. No.: 19/128,641

(22) PCT Filed: Nov. 2, 2023
(86) PCT No.: PCT/IB2023/061065

§ 371 Date: May 9, 2025

Related U.S. Application Data
(60) Provisional application No. 63/424,790, filed on Nov. 11, 2022.

(51) Int. Cl. H01M 10/0587; H01M 10/04; H01M 50/107

(52) U.S. Cl. CPC H01M 10/0587; H01M 10/049; H01M 50/107

(57) ABSTRACT

Electrochemical cells including an outer constraint and methods of making the same are provided. The electrochemical cells include a coil electrode defining a cylindrical core and extending circumferentially about the core. The coil electrode includes an anode, a cathode, and a separator and an electrolyte therebetween. The outer constraint extends circumferentially about the coil electrode and radially compresses the coil electrode to hold it under a radial stack pressure. Electrochemical cells including a constraint electrode and methods of making the same are provided. The electrochemical cells further include a winding core and a staked electrode. The staked electrode includes a core portion staked to the winding core and a coil portion wound spirally about the winding core. The constraint electrode includes a coil portion wound spirally about the winding core and a constraint portion. The constraint portion extends circumferentially about and radially compress the coil portions of the electrodes.

This application claims the benefit of U.S. Patent Application No. 63/424,790, filed 11 Nov. 2022, the entire content of which is incorporated herein by reference.

### TECHNICAL FIELD

This disclosure generally relates to, among other things, wound cell batteries or electrochemical cells.

### BACKGROUND

Wound cell batteries or electrochemical cells are generally easy to manufacture and provide robust mechanical stability. Such wound cell batteries or electrochemical cells may include an anode, a cathode, and a separator in the form of strips wound in a spiral or coil. Wound cell batteries or electrochemical cells may be used as power sources, such as in medical devices, implantable medical devices, portable electronic devices, or electric vehicles.

In many applications, such as implantable medical devices, medical devices, and portable electronic devices, miniaturization of cell batteries is desirable. In the case of implantable medical devices, miniaturization of cell batteries may contribute substantially to miniaturization of the implantable medical device, itself. It is generally desirable to miniaturize implantable medical devices because miniaturization may, for example, increase availability of non-invasive procedures for implantation, improve patient recovery outcomes, and improve patient comfort.

In general, cell batteries with greater energy density are desirable for a battery to meet the needs of a device, such as to last longer on a charge or to meet greater demand for energy. Increased energy density is also desirable for miniaturization of cell batteries to meet the energy needs of devices for which small formfactor size is important. In general, the energy density of a primary cell (that is, a cell configured to be discharged once and then discarded or recycled) is greater than the energy density of a secondary cell (that is, a rechargeable cell configured to be cycled through charge and discharge cycles for repeated use). In many applications, rechargeable batteries are preferred over primary batteries for benefits such as improving the lifespan of a device, meeting the average power need of the device, and reducing waste.

Rechargeable batteries are especially desirable where replacing a primary battery would be difficult or impossible, such as in implantable medical devices, where accessing the device to replace its battery (or the device itself) could require an inpatient procedure. However, rechargeable batteries in implantable medical devices generally must be recharged frequently because of lower energy density and small form factor.

In some cell batteries, such as in a lithium metal rechargeable system, the stack pressure placed on the electrode structures can improve the energy density of a cell. In other words, placing a higher mechanical load across the electrode structure generally increases such a cell battery's energy density. Another benefit to stack pressure can be immobilization or fixation of the electrode structure, which will generally expand and contract during charge and discharge cycling. The expansion and contraction of the electrode structure can strain components of a cell, such as current collectors, and can reduce the service life of a cell. Expansion and contraction during charge and discharge cycling can be more pronounced in cells with wound electrode structures.

In many use cases and form factors, achieving a high stack pressure is more difficult. This may include some wound cell batteries, batteries with a small form factor, or a wound cell battery with a small form factor. For application in implantable medical devices, achieving stack pressure could improve energy density—offering miniaturization and increased capacity—and more charge and discharge cycles in the service life of a cell.

In general, there is a need for a rechargeable wound cell battery with a high stack pressure to provide increased energy density, ease of manufacturing, robust mechanical stability, and stable battery cycling. In particular, a rechargeable wound cell battery with a high stack pressure is needed to provide increased energy capacity, ease of manufacturing, robust mechanical stability, and stable battery cycling, which could improve the lives, comfort, and quality of care for patients living with or receiving implantable medical devices such as pacemakers, insulin pumps, cardioverter-defibrillators, drug delivery pumps, and neurostimulators.

### SUMMARY

Disclosed herein are electrochemical cells and methods of manufacturing the same with coiled electrode structures that can achieve radial stack pressures similar to the stack pressures achieved in large electrochemical cells with stacked electrode structures and assisted stack loading. The electrochemical cells disclosed herein and the methods of manufacturing the same are suitable for small form factors. The electrochemical cells and methods of making the same disclosed herein are useful for achieving higher energy densities in rechargeable batteries, and even energy densities comparable to the energy densities of primary batteries.

In one example, aspects of this disclosure relate to an electrochemical cell including a coil electrode. The coil electrode may define a cylindrical core and extend circumferentially about the cylindrical core. The coil electrode may include an anode, a cathode, a separator between the anode and the cathode, and an electrolyte between the anode and the cathode. The electrochemical cell may further include an outer constraint that extends circumferentially about the coil electrode. The outer constraint may radially compress the coil electrode to hold the coil electrode under a radial stack pressure. The outer constraint may radially fixate the coil electrode.

In another example, aspects of this disclosure relate to an electrochemical cell including a winding core that defines a longitudinal axis. The electrochemical cell may further include a staked electrode. The staked electrode may include a core portion fixedly coupled to the winding core and a coil portion wound spirally about the winding core. The electrochemical cell may further include a constraint electrode. The constraint electrode may include a coil portion and a constraint portion. The coil portion of the constraint electrode may be wound spirally about the winding core and at least a portion of the coil portion of the staked electrode. The constraint electrode may further include a constraint portion. The constraint portion of the constraint electrode may extend circumferentially about and radially compress the coil portion of the constraint electrode and the coil portion of the staked electrode. The constraint portion of the constraint electrode may also radially fixate the coil portion of the constraint electrode and the coil portion of the staked electrode. The electrochemical cell may further include a separator wound spirally about the winding core between the coil portion of the staked electrode and the coil portion of the constraint electrode. The electrochemical cell may further include an electrolyte between the coil portion of the staked electrode and the coil portion of the constraint electrode. The staked electrode and the constraint electrode may be of opposite polarities.

In yet another example, aspects of this disclosure relate to a method of manufacturing an electrochemical cell. The method includes inserting a coil electrode into a cylindrical canister. The cylindrical cannister may include an inner surface. The coil electrode may define a tubular void and may include an anode, a cathode, and a separator between the anode and the cathode. The anode, the cathode, and the separator may be wound about the tubular void. The method may further include inserting the coil electrode into a cylindrical canister and inserting an expander plug into the tubular void. The inserting the expander plug into the tubular void may radially compress the coil electrode between the expander plug and the inner surface of the cylindrical canister, thereby applying a radial stack pressure to the coil electrode. The inserting the expander plug into the tubular void may further radially fixate the coil electrode.

In still another example, aspects of this disclosure relate to a method of manufacturing an electrochemical cell. The method may include winding a coil electrode around a core. The coil electrode may include an anode, a cathode, and a separator between the anode and the cathode. The method may further include winding one of the anode or the cathode around the coil electrode, which may establish an outer constraint. The outer constraint may radially compress the coil electrode and applying a radial stack pressure thereto. The outer constraint may also radially fixate the coil electrode.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1A is a perspective view of an electrochemical cell in accordance with one or more embodiments of the present disclosure with a closed housing.

FIG. 1B is a perspective view of the electrochemical cell of FIG. 1A with the housing open to show an electrode coil.

FIG. 1C is a partially exploded perspective view of the electrochemical cell of FIG. 1A.

FIG. 1D is a cross sectional side view of the electrochemical cell of FIG. 1A.

FIG. 2A is a cross sectional side view of an electrochemical cell in accordance with one or more embodiments of the present disclosure.

FIG. 2B is a cross sectional elevation view of the electrochemical cell of FIG. 2A.

FIG. 3 is a diagram of a method of making an electrochemical cell in accordance with one or more embodiments of the present disclosure.

FIGS. 4A-4B are a diagram of a method of making an electrochemical cell in accordance with one or more embodiments of the present disclosure.

The figures are rendered primarily for clarity and, as a result, are not necessarily drawn to scale. Moreover, various structure/components may be shown diagrammatically or removed from some or all of the views to better illustrate aspects of the depicted embodiments, or where inclusion of such structure/components is not necessary to an understanding of the various exemplary embodiments described herein. The lack of illustration/description of such structures/components in a particular figure is, however, not to be interpreted as limiting the scope of the various embodiments in any way.

### DETAILED DESCRIPTION

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer”, “polymerized monomers”, and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “substantially” modifies the term that follows by at least about 90%, at least about 95%, or at least about 98%. “Substantially” includes “significantly,” which refers to statistical significance.

The term “not substantially” modifies the term that follows by not more than 25%, not more than 10%, not more than 5%, or not more than 2%.

In this disclosure, all numbers are assumed to be modified by the term “about,” which encompasses the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. The terms “and/or” and “any combination thereof” and their grammatical equivalents as used herein, can be used interchangeably. These terms can convey that any combination is specifically contemplated. Solely for illustrative purposes, the following phrases “A, B, and/or C” or “A, B, C, or any combination thereof” can mean “A individually; B individually; C individually; A and B; B and C; A and C; and A, B, and C.” The term “or” can be used conjunctively or disjunctively unless the context specifically refers to a disjunctive use.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to”, “at most”, or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. It is contemplated that any embodiment discussed in this specification can be implemented with respect to any method or composition of the present disclosure, and vice versa. Furthermore, compositions of the present disclosure can be used to achieve methods of the present disclosure. Such inclusive or open-ended words encompass more restrictive or closed terms or phrases, such as “consisting” or “consisting essentially.”

As used herein, “consisting essentially of” means that the article or method consisting essentially of listed elements may include additional elements that do not materially affect the basic and novel characteristics of the article or method.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Reference in the specification to “some embodiments,” “an embodiment,” “one embodiment,” “embodiments,” “one or more embodiments,” or “other embodiments” means that a particular feature, structure, or characteristic described in connection with the embodiments is included in at least some embodiments, but not necessarily all embodiments, of the present disclosures.

Any direction referred to herein, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

In several places throughout the application, guidance is provided through examples, which examples, including the particular aspects thereof, can be used in various combinations and be the subject of claims. In each instance, the recited list serves only as a representative group and should not be interpreted as an exclusive list. It is to be understood that the particular examples, materials, amounts, and procedures are to be interpreted broadly in accordance with the scope and spirit of the invention as set forth herein.

Reference will now be made in greater detail to various embodiments of the subject matter of the present disclosure, one or more embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

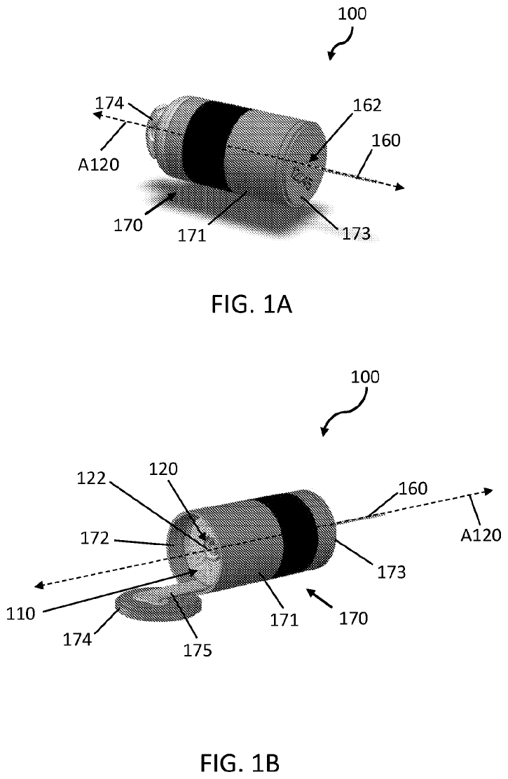

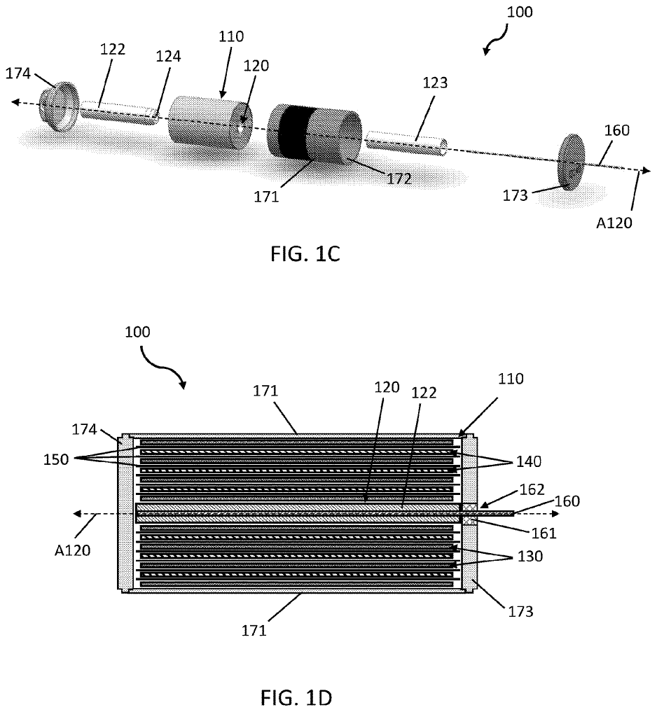

Referring now to FIGS. 1A-1D, an embodiment of an electrochemical cell 100 is shown. The electrochemical cell 100 includes a coil electrode 110 defining a cylindrical core 120. A longitudinal axis A120 is defined by the cylindrical core 120. The coil electrode 110 extends circumferentially about the cylindrical core 120. The coil electrode 110 may be enclosed in a housing (e.g., the housing 170). The coil electrode 110 includes a first electrode 130 and a second electrode 140, as shown in FIG. 1D. Each of the first electrode 130 and the second electrode 140 includes a plurality of windings about the cylindrical core 120. The first electrode 130 and the second electrode 140 are separated from each other by one or more separators (e.g., a separator 150, as shown in FIG. 1D).

The electrochemical cell 100 may be any suitable electrochemical cell type such as, for example, lithium metal, lithium ferrophosphate, or lithium iron phosphate (LFP), lithium nickel manganese cobalt oxide (NMC), lithium nickel cobalt aluminum oxide (NCA), lithium titanate, etc.

In embodiments according to this disclosure, the electrochemical cell 100 may have an energy density of 100 Wh/l or greater, 200 Wh/l or greater, 300 Wh/l or greater, 400 Wh/l or greater, 450 Wh/l or greater, 500 Wh/l or greater, 600 Wh/l or greater, 700 Wh/l or greater, or 800 Wh/l or greater. Energy density of the electrochemical cell 100 may be measured using any suitable method. Suitable methods may include, for example, the measured energy capacity (e.g., measured in watt-hours) of the electrochemical cell 100 divided by the volume of the electrochemical cell (e.g., measured in liters). The energy capacity of the electrochemical cell 100 may be measured using any suitable method or apparatus. Suitable methods or apparatuses may include, for example, a battery analyzer (e.g., FLUKE BT520 battery analyzer, MACCOR Series 4000 multi-channel cell test system).

In an embodiment, the housing 170 includes a hollow body 171 extending circumferentially about the coil electrode 110. The hollow body 171 has an inner surface 172. The housing 170 may include one or both of a header 173 and an end cover 174. The header 173 may be coupled to an end of the housing 170 and the end cover 174 may be coupled to the other end of the housing 170. The header 173 and the end cover 174 may be coupled to the housing 170, for example, by an adhesive, a weld process, or a crimp closure.

As shown in FIG. 1A, the header 173 may include one or more feedthrough holes (e.g., a feedthrough hole 162). The one or more feedthrough holes may be, for example, for passage of a feedthrough pin 160 or a current collector into the housing 170. Additionally or alternatively, the end cover 174 may include one or more feedthrough holes. The housing 170, including any of the hollow body 171, the header 173, and the end cover 174, may be made of any suitable material. Suitable housing materials may include aluminum, titanium, stainless steel, nickel, nickel coated ferrous steels, or other suitable materials. In one or more embodiments, the housing 170 may include a polymeric material.

In an embodiment, the first electrode 130 includes a plurality of first electrode windings around the longitudinal axis A120. The first electrode 130 may be coupled to one or more first current collectors, such as a first feedthrough pin 160. Alternatively or additionally, the first electrode 130 may be electrically connected indirectly to one or more first current collectors, such as the first feedthrough pin 160, via one or more conductive elements (e.g., the expander plug 122 or a core insert 123) interposed between them. The first electrode 130 may be of any suitable thickness. Suitable first electrode thicknesses may include 0.1 mm or less, 0.15 mm or less, 0.2 mm or less, 0.25 mm or less, 0.3 mm or less, 0.35 mm or less, 0.4 mm or less, or 0.5 mm or less.

The first electrode 130 may be a strip of electrode material (i.e., a substantially rectangular piece of electrode material having a width and having a linear length greater than the width). The first electrode strip may be of any suitable linear length. Suitable first electrode strip linear lengths may include 30 mm or less, 40 mm or less, 50 mm or less, 60 mm or less, 70 mm or less, 80 mm or less, 90 mm or less, 100 mm or less, 120 mm or less, 140 mm or less, 160 mm or less, 180 mm or less, or 200 mm or less. Suitable first electrode strip linear lengths may also include 10 cm or more, 15 cm or more, 20 cm or more, 30 cm or more, 40 cm or more, or 50 cm or more. The first electrode strip width may be of any suitable width. Suitable first electrode strip widths may include 4 mm or less, 6 mm or less, 8 mm or less, 9 mm or less, 10 mm or less, 15 mm or less, 20 mm or less, 30 mm or less, 40 mm or less, or 50 mm or less. Suitable first electrode widths may also include 1 cm or more, 2 cm or more, 5 cm or more, 10 cm or more, or 15 cm or more.

In an embodiment, the second electrode 140 includes a plurality of second electrode windings around the longitudinal axis A120. The polarity of the second electrode 140 is opposite to the polarity of the first electrode 130. That is, in embodiments with an anode electrode as the first electrode 130, a cathode electrode is the second electrode 140, or vice versa.

In an embodiment, the second electrode 140 is electrically insulated from the cylindrical core 120, for example, by the separator 150. The second electrode 140 may be electrically insulated from the first electrode 130, for example, by the separator 150. The second electrode 140 may be coupled to one or more second current collectors, such as a second electrode tab 175. Additionally or alternatively, the second electrode 140 may be coupled or electrically connected to one or more second current collectors, such as a second feedthrough pin (not shown in FIGS. 1A-1D). The second electrode 140 may be of any suitable thickness. Suitable second electrode thicknesses may include 0.1 mm or less, 0.15 mm or less, 0.2 mm or less, 0.25 mm or less, 0.3 mm or less, 0.35 mm or less, 0.4 mm or less, or 0.5 mm or less.

The second electrode 140 may be a strip of electrode material. The second electrode strip may be of any suitable linear length. Suitable second electrode strip linear lengths may include 30 mm or less, 40 mm or less, 50 mm or less, 60 mm or less, 70 mm or less, 80 mm or less, 90 mm or less, 100 mm or less, 120 mm or less, 140 mm or less, 160 mm or less, 180 mm or less, or 200 mm or less. Suitable second electrode strip linear lengths may also include 10 cm or more, 15 cm or more, 20 cm or more, 30 cm or more, 40 cm or more, or 50 cm or more. The second electrode strip width may be of any suitable width. Suitable second electrode strip widths may include 4 mm or less, 6 mm or less, 8 mm or less, 9 mm or less, 10 mm or less, 15 mm or less, 20 mm or less, 30 mm or less, 40 mm or less, or 50 mm or less. Suitable second electrode widths may also include 1 cm or more, 2 cm or more, 5 cm or more, 10 cm or more, or 15 cm or more.

The second electrode tab 175 may include an extension of the electrode material of the second electrode 140. Additionally or alternatively, the second electrode tab 175 may include a separate material electrically coupled to the electrode material of the second electrode 140.

The coil electrode may include an anode electrode, which may be the first electrode 130 or the second electrode 140. The anode electrode may be made of any suitable material. Suitable anode electrode materials may include copper, lithium, graphite, lithium-alloying materials, intermetallic materials (e.g., alloys), or silicon. In one or more embodiments, the anode electrode may include a copper foil. The copper foil may include a layer of metallic lithium, such as a coating or plating of lithium or of a lithium alloy. The layer of metallic lithium may be of any suitable thickness. Suitable metallic lithium thicknesses may include, for example, 1 micron or less, 5 microns or less, 10 microns or less, 15 microns or less, or 20 microns or less. Suitable metallic lithium thicknesses may further include, for example, 5 microns or more, 10 microns or more, 15 microns or more, 20 microns or more, 30 microns or more, or 50 microns or more.

The coil electrode may include a cathode electrode, which may be the first electrode 130 or the second electrode 140. The cathode electrode may be made of any suitable material. Suitable cathode electrode materials may include lithium-metal oxides (e.g., LiCoO₂, LiMn₂O₄, Li(NixMnyCoz)O₂, etc.), vanadium oxides, olivines (e.g., LiFePO₄), rechargeable lithium oxides, silver vanadium oxide, carbon monofluoride, or manganese dioxide.

The separator 150 is disposed or sandwiched between the first electrode 130 and the second electrode 140. The separator 150 may be in intimate contact with one or both of the first electrode 130 and the second electrode 140. The separator 150 may include two independent strips, each establishing a plurality of separator windings around the cylindrical core 120 and between the first electrode 130 and the second electrode 140. Additionally or alternatively, the separator 150 may be tubular to receive one of the first electrode 130 or the second electrode 140, establishing a plurality of separator windings around the cylindrical core 120 and between the first electrode 130 and the second electrode 140.

The separator 150 may be porous, microporous, perforated or may include holes for electrolyte to penetrate to inner layers or windings of the coil electrode 110. Accordingly, the separator 150 may facilitate ion transfer within inner layers or windings of the coil electrode 110 because an electrolyte (described below) provides a medium for ion transfer, for example, between the first electrode 130 and the second electrode 140. The separator 150 may be made of any suitable material. Suitable separator materials may include, polypropylene, polyethylene, Polytetrafluoroethylene (PTFE), cellophane, nylon, polyolefin, microporous membrane, or multilayer microporous membrane (e.g., CELGARD® 2320 Trilayer Microporous Membrane). The separator 150 may be any suitable thickness. Suitable separator thicknesses may include 5 μm or less, 10 μm or less, 20 μm or less, 30 μm or less, 40 μm or less, or 50 μm or less.

In an embodiment, the electrochemical cell 100 includes an outer constraint, which extends circumferentially about the coil electrode 110. The outer constraint radially compresses the coil electrode 110 to hold the coil electrode 110 under a radial stack pressure. The outer constraint may substantially immobilize or radially fixate the electrode coil 110, thereby preventing or inhibiting radial expansion or contraction of the electrode coil 110. The radial stack pressure may be any suitable pressure. Suitable radial stack pressures include, for example, 0.1 MPa or greater, 0.3 MPa or greater, 0.5 MPa or greater, 0.7 MPa or greater, 0.9 MPa or greater, or 1 MPa or greater. Radial stack pressure may be measured using any suitable method, such as, for example, by using a polymeric pressure sensitive film (e.g., FUJIFILM PRESCALE pressure sensitive film). In methods for measuring radial stack pressure using a polymeric pressure sensitive film, the polymeric pressure sensitive film may be inspected immediately after formation of the cell.

In embodiments in accordance with FIGS. 1A-1D, the hollow body 171 of the housing 170 may establish the outer constraint. In such embodiments, the outer surface (that is, the outermost winding) of the coil electrode 110 may be in contact with the inner surface 172 of the hollow body 171, thereby radially compressing the coil electrode 110.

In embodiments according to FIGS. 1A-1D, the cylindrical core 120 may receive an expander plug 122, to press the coil electrode 110 radially outward against the inner surface 172 of the hollow body 171. The outer constraint may radially compress the coil electrode 110 against the expander plug 122. The expander plug 122 may restrict inward radial deformation of the coil electrode 110 to prevent collapse or deformation of the cylindrical core 120. The expander plug 122 may maintain the coil structure of the coil electrode 110 subject to the radial compression of the outer constraint (that is, the hollow body 171). The expander plug 122 may receive or otherwise couple to a feedthrough pin, such as the first current collector 160. The expander plug 122 may be electrically coupled to the first current collector 160, such as by intimate contact or by welding (e.g., laser or resistance welding). The expander plug 122 may be made of any suitable material. Suitable expander plug materials include aluminum, titanium, stainless steel, nickel, nickel coated ferrous steels, or other suitable materials. The expander plug 122 may include a polymeric material.

In one or more embodiments, the coil electrode 110 may receive the core insert 123 (as shown in FIG. 1C). The core insert 123 may include a winding disposed between the cylindrical core 120 and the innermost coil of the coil electrode 110. The core insert 123 may improve reception of the expander plug 122.

For example, in an embodiment where the first electrode 130 and the expander plug 122 do not slide easily against each other (i.e., the first electrode material and the expander plug material exhibit a high-friction interaction), the core insert 123 may be made with a material having a more desirable frictional interaction with the first electrode 130 or the expander plug 122. In another example, in an embodiment where the first electrode is delicate (e.g., where the first electrode 110 is made of copper foil) and could be damaged by directly receiving the expander plug 122, the core insert 123 may be made of a more durable or resilient material (e.g., titanium foil) to protect the first electrode 110 from being damaged by receiving the expander plug 122.

The core insert 123 may be made of any suitable material. Suitable core insert materials may include, for example, titanium, titanium foil, aluminum, or aluminum foil. The core insert 123 may be made of a conducting material or an insulating material.

The electrochemical cell 100 may include one or more current collectors, each electrically coupled to one of the electrodes (e.g., the feedthrough pin 160 electrically coupled to the first electrode 130 via the cylindrical core 120, as shown in FIGS. 1B-1D). The one or more current collectors may extend from their respective electrical coupling points to outside the housing 170. The one or more current collectors may extend through one or more feedthrough holes in the housing 170. For example, as shown in FIGS. 1A-1D, the first feedthrough pin 160 extends through the first feedthrough hole 162 in header 173. The first feedthrough pin 160 may be electrically coupled directly to the first electrode 130. The first feedthrough pin 160 may additionally or alternatively be electrically coupled indirectly to the first electrode 130 via one or more conductive elements (e.g., the expander plug 122, as shown in FIG. 1B, or the core insert 123, as shown in FIG. 1C) interposed between them. The one or more current collectors may be electrically insulated from the housing 170, as shown in FIG. 1D with respect to the first feedthrough pin 160. The feedthrough pin 160 may be inserted through a channel 124 extending through the expander plug 120. The feedthrough pin 160 may be welded to the expander plug 122 to provide robust electrical connection between a conductive expander plug 122 and the feedthrough pin 160.

The electrochemical cell 100 may include one or more feedthrough insulators, such as a first feedthrough insulator 161 (shown in FIG. 1D). The feed through insulators may be disposed in the housing 170, such as in one or both of the header 173 or the end cover 174, to electrically insulate the housing from electrical interconnects such as between the header 173 and the current collectors (e.g., the first feedthrough pin 160) or between the end cover 174 and the current collectors.

An embodiment of the electrochemical cell 100 includes an electrolyte disposed in the housing. Although not explicitly labeled in the figures, the electrolyte may generally fill at least a portion of any spaces inside the housing not filled by the other components of the electrochemical cell 100. The electrolyte may facilitate ion transfer between the first electrode 130 and the second electrode 140. The electrolyte may have an electrical potential. The electrolyte may include any suitable material and may be one or more of, for example, a liquid, a gel, or a paste. The material composition of the electrolyte may depend on a cell type of the electrochemical cell. The electrolyte may include, for example, lithium salt, sulfuric acid, fluorinated sulfone, or other suitable electrolyte. The electrolyte may include a non-aqueous solution in which a lithium salt (e.g., lithium hexafluorophosphate salt) is dissolved in an organic carbonate solvent (e.g., mixtures including one or more of ethylene carbonate, dimethyl carbonate, propylene carbonate, diethyl carbonate, or ethyl methyl carbonate). The electrochemical cell 100 may include a volume not filled by electrolyte (i.e., a void). The void may remain in the electrochemical cell 100 to avoid overpressure of the enclosure. The electrochemical cell 100 may include various insulators (not shown in the figures) to insulate the conductive components (e.g., the housing 170; the first feedthrough pin 160; the first electrode 130, the second electrode 140, etc.) from one another. The insulators may be made of any suitable material. Suitable insulator materials may include, for example, polytetrafluoroethylene (PTFE), polysulfone, glass, ceramic materials (e.g., alumina).

The electrochemical cell 100 may include various electrical connections, such as between conductive components (e.g., between the first feedthrough pin 160 and the expander plug 122, between the first feedthrough pin 160 and the first electrode 130, or between the second electrode 140 and the end cover 174). Such electrical connections may be made by intimate contact between two or more conducting materials. Additionally or alternatively, such electrical connections may be made by welding two or more conducting materials together (e.g., by resistance welding or laser welding). Where conducting materials have at least slightly incompatible metallurgical characteristics (such as in a connection between titanium and copper), a weld interposer (e.g., a vanadium weld interposer) may be used to manage weld stability and strength.

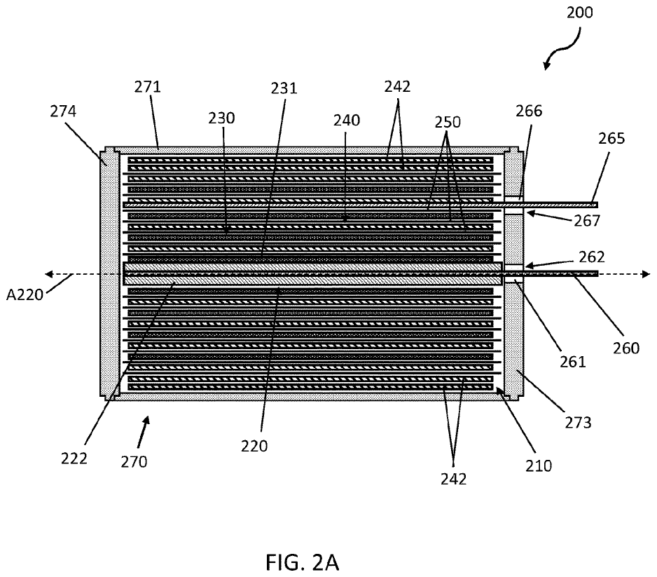

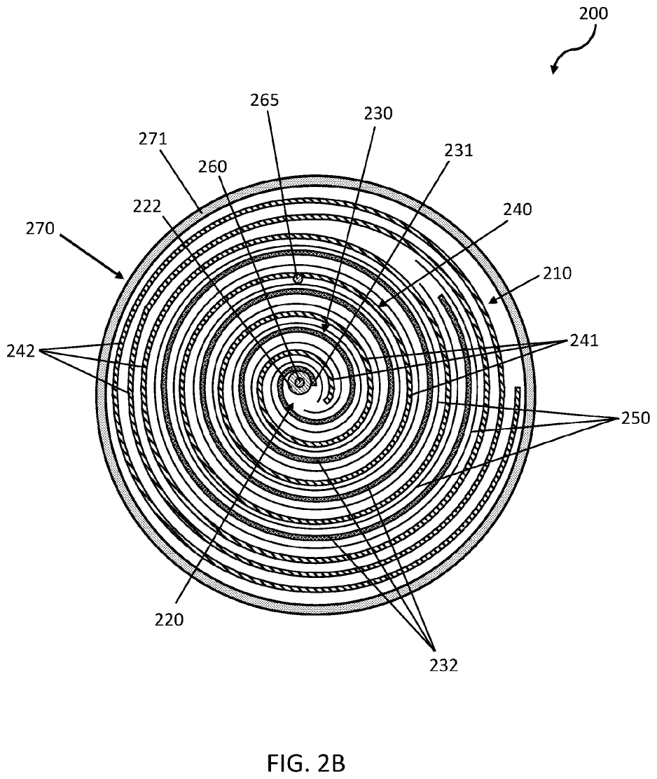

Referring now to FIGS. 2A and 2B, an embodiment of an electrochemical cell 200 is shown, including a coil electrode 210 disposed in a housing 270. The coil electrode 210 includes a first electrode 230 and a second electrode 240. The coil electrode 210 defines a cylindrical core 220. A longitudinal axis A220 is defined by the cylindrical core 220. The coil electrode 210 extends circumferentially about the cylindrical core 220. The coil electrode 210 may be enclosed in a housing (e.g., the housing 270 defining a hollow tube 271 into which the coil electrode 210 may be inserted). Each of the first electrode 230 and the second electrode 240 includes a plurality of windings about the cylindrical core 220. The first electrode 230 and the second electrode 240 are separated from each other by the separator 250.

In an embodiment, the cylindrical core 220 includes a winding core 222. The coil electrode 210 may be wound around the winding core 222. The winding core 222 may be made of any suitable material. Suitable winding core materials include, for example, aluminum, titanium, stainless steel, nickel, nickel coated ferrous steels, or other suitable materials. In one or more embodiments, the winding core 222 may include a polymeric material.

In one or more embodiments according to FIGS. 2A and 2B, the first electrode 230 may be a staked electrode having a core portion 231 fixedly coupled (e.g., by welding) to the winding core 222. The core portion 231 may be electrically connected to the winding core 222 (e.g., by welding). The core portion 231 may be welded to the winding core 222, for example, by resistance welding or laser welding. The core portion 231 may be welded to the winding core 222 using a weld interposer, such as a vanadium weld interposer, to manage weld stability and strength.

The first electrode 230 may further include a winding portion 232 having a plurality of first electrode windings wound about the winding core 222. The winding portion 232 may be electrically connected to the core portion 231. The winding portion 232 may be made of the same material as the core portion 231. The winding portion 232 extends from the core portion 231. In one or more embodiments, the winding portion 232 and the core portion 231 comprise different materials. The first electrode 230 may be an anode electrode or a cathode electrode.

The first electrode 230 may be electrically connected to a current collector, such as a central feedthrough pin 260. The first electrode 230 may be electrically connected to the central feedthrough pin 260 directly (e.g., via welding). In an embodiment, the first electrode 230 is electrically connected to the central feedthrough pin 260 indirectly, such as by the winding core 222 or other conductive elements interposed between them. The central feedthrough pin 260 may extend through a central feedthrough hole 262. The central feedthrough pin 260 may be insulated from the housing 270 by a central feedthrough insulator 261.

In one or more embodiments according to FIGS. 2A and 2B, the second electrode 240 may be a constraint electrode having a constraint portion 242. The constraint portion 242 may establish the outer constraint, which retains the coil electrode 110 in a tightly wound configuration to maintain stack pressure and energy density, as described above. In one or more embodiments, a fixing mechanism (not shown) is applied to the constraint portion 242 to retain the outer constraint. Any suitable fixing mechanism may be applied. For example, an adhesive, an adhesive tape, a weld, or the like may be used to retain the constraint portion 242 to establish the outer constraint. The constraint portion 242 may include a winding having at least a portion overlapping with another portion, which may further be in intimate contact with another portion. The constraint portion 242 may additionally or alternatively include a plurality of windings in intimate contact with each other. The constraint portion 242 may include a portion fixedly coupled to another portion of the constraint portion 242 or another portion of the coil electrode.

The second electrode 240 may further include a winding portion 241 having a plurality of second electrode windings wound about the winding core 222. The winding portion 241 may be electrically connected to the constraint portion 242. The winding portion 241 may be made of the same material as the constraint portion 242. Alternatively or additionally, the winding portion 241 and the constraint portion 242 may be made of different materials. The second electrode 240 may be an anode electrode or a cathode electrode. The second electrode 240 may be electrically insulated from the first electrode 230, for example, by the separator 250. The second electrode may be electrically insulated from the winding core 222, for example, by the separator 250.

The second electrode 240 may be electrically connected to a current collector, such as a radial feedthrough pin 265. The second electrode 240 may be electrically connected to the radial feedthrough pin 265 directly (e.g., via welding). The second electrode 240 may electrically connected to the radial feedthrough pin 265 indirectly, such as by conductive elements interposed between them. The radial feedthrough pin 265 may extend through a radial feedthrough hole 267. The radial feedthrough pin 265 may be insulated from the housing 270 by a central feedthrough insulator 266.

In some embodiments, electrochemical cell 200 has a “case neutral” design. In other words, the housing 270 may float at the electrolyte potential of the electrochemical cell 200. To achieve a case neutral design, the electrochemical cell may include a current collector that extends through the housing while being insulated from the housing by a feedthrough insulator. Accordingly, the header 273 of the housing 270 may include feedthrough insulators (e.g., the central feedthrough insulator 261 and the radial feedthrough insulator 266) for each of the current collectors (e.g., the central feedthrough pin 260 and the radial feedthrough pin 265, respectively).

Electrochemical cells described herein (e.g., cells 100, 200) may be manufactured in any suitable manner. In embodiments, a coil electrode, as described herein, is inserted into a cylindrical housing having a hollow body, the hollow body having an inner surface. The coil electrode may define a tubular void (i.e., a cylindrical core). The coil electrode may comprise a winding core. The coil electrode may include an anode electrode wound spirally around the tubular void, a cathode electrode wound spirally around the tubular void, and a separator between the anode electrode and the cathode electrode, the separator also wound spirally around the tubular void or the winding coil.

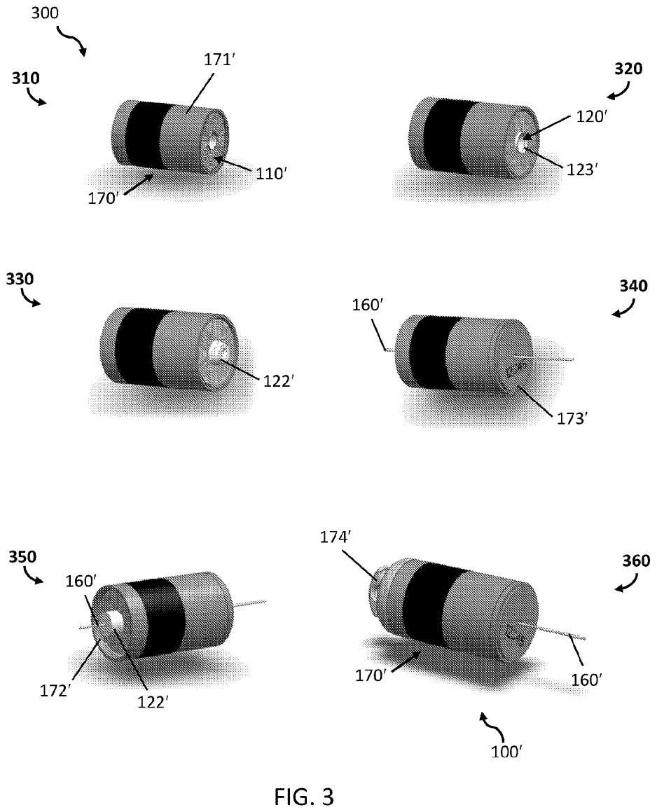

Referring now to FIG. 3, an embodiment of a method 300 of manufacturing an embodiment of an electrochemical cell 100′ is shown. The electrochemical cell 100′ is otherwise similar to the cell shown in FIGS. 1A-1D. The method 300 may include step 310: inserting a coil electrode 110′ into a hollow body 171′ of a housing 170′. The method 300 may further include step 320: inserting 320 the core insert 123′ into the cylindrical core 120′. The method 300 may further include step 330, inserting an expander plug 122′ into the cylindrical core 120′ to radially compress the coil electrode 110′ between the expander plug 122′ and the inner surface 172′ of the hollow body 171′, thereby applying a radial stack pressure to the coil electrode 110′. The method 300 may include step 340, which may include coupling a header 173′ to the hollow body 171′. Step 340 may include inserting a feedthrough pin 160′ through the expansion plug 122′. The method 300 may further include step 350: welding the feedthrough pin 160′ onto the expansion plug 122′. The method 300 may further include step 360: coupling an end cover 174′ to the hollow body 171′.

In some embodiments of the method of manufacturing an electrolytic cell, the method may further include winding a coil electrode around a core. The coil electrode may include an anode electrode, a cathode electrode, and a separator between the anode electrode and the cathode electrode.

In some embodiments of the method of manufacturing an electrolytic cell may include winding one of the anode or the cathode around the coil electrode, establishing an outer constraint. The outer constraint may radially fixate the outer diameter of the coil electrode and compress the coil electrode after cell formation, applying a radial stack pressure thereto.

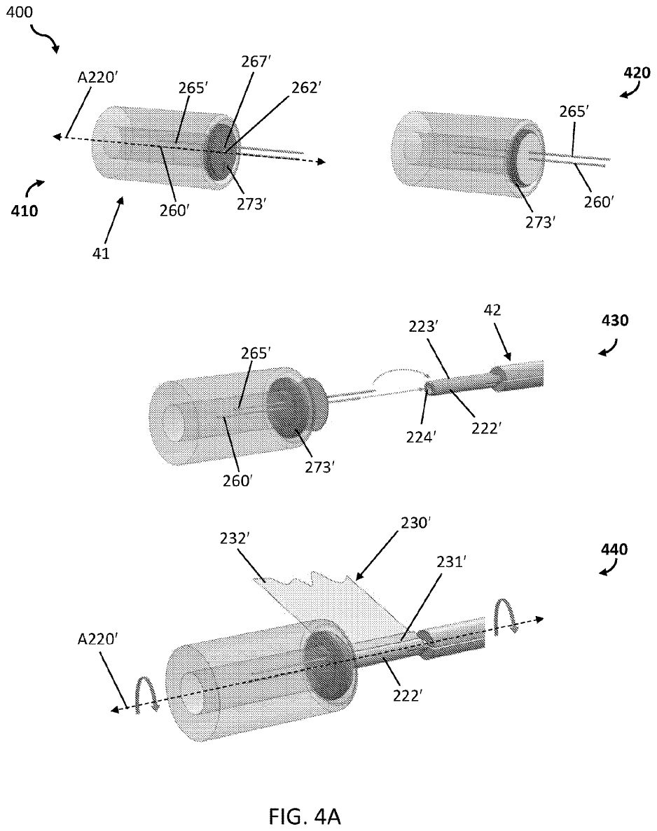

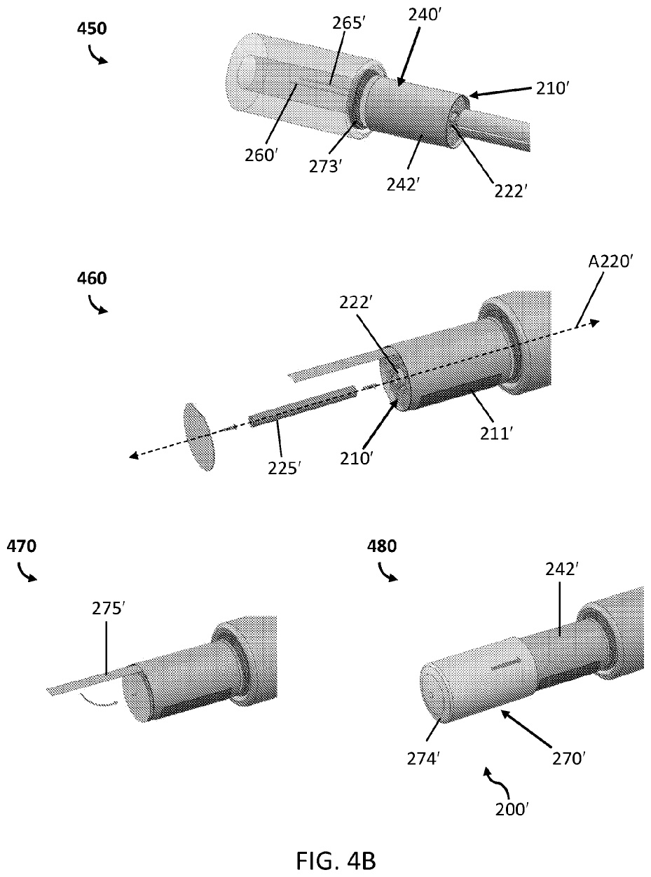

Referring now to FIGS. 4A and 4B, which show an embodiment of a method 400 of manufacturing an embodiment of an electrochemical cell 200′ is shown. The electrochemical cell 200′ is otherwise similar to the cell shown in FIGS. 2A and 2B. The electrochemical cell 200′ depicted in FIGS. 4A and 4B includes a central feedthrough pin 261′ electrically connected to a second electrode 240′ (that is, the constraint electrode) via a second electrode tab 275′. The electrochemical cell 200′ depicted in FIGS. 4A and 4B includes a radial feedthrough pin 265′ connected to a first electrode 230′ (that is, the staked electrode) via a weld electrically connecting the radial feedthrough pin 265′ and the staked portion 231′ of the first electrode 230′, which weld also fixedly couples the staked portion 231′ of the first electrode 230′ to the winding core 222′.

The method 400 may include step 410: inserting a central feedthrough pin 260′ through a central feedthrough hole 262′ in a header 273′ and inserting a radial feedthrough pin 265′ through a radial feedthrough hole 267′ in the header 173′. The header 273′ may be secured to a chuck, such as vacuum chuck 41. The method 400 may further include step 420: adding a disk insulator to header 273′. The method 400 may further include step 430: aligning a winding core 222′ with the header 273′. Step 430 may include inserting the central feedthrough pin 260′ into a center bore 224′ of the winding core 222′. Step 430 may also include aligning the radial feedthrough pin 265′ with the radial slot 223′ of the winding core 222′. The winding core may be secured to a chuck, such as rotary chuck 42.

The method 400 may further include step 440: welding the staked portion 231′ of the first electrode 230′ (that is, the staked electrode) to the radial feedthrough pin 265′ and the winding core 222′. The welding may electrically couple the staked portion 231′ of the first electrode 230′ to the radial feedthrough pin 265′. The welding may also fixedly couple (i.e., stake) the staked portion 231′ of the first electrode 230′ to the winding core 222′. Step 440 may also include winding the electrode coil 210′, beginning with the first electrode 230′ and followed by the second electrode 240′, and the separator (not shown in FIGS. 4A and 4B) about the winding core 222′.

The method 400 may further include step 450: completing winding of the electrode coil 210′ with at least one winding of the second electrode 240′, establishing the constraint portion 242′ of the second electrode 240′.

The method 400 may further include step 460, which may include immobilizing or fixating the coil electrode 210′, for example with a piece of tape 211′ or other fastener. Step 460 may further include adding insulation, such as by inserting core insulation 225′ into the center bore 224′ of the winding core 222′, which may insulate the central feedthrough pin 260′ from other conducting elements. Step 460 may further include forming or attaching a second electrode tab 275′, which may be electrically connected to the second electrode 240′.

The method 400 may further include step 470: electrically connecting the central feedthrough pin 260′ and the second electrode tab 275′, such as by welding. Step 470 may include fixedly coupling the second electrode tab 275′ to the central feedthrough pin 260′, such as by welding.

The method 400 may further include step 480: inserting the coil electrode 210′ into a hollow body 271′. Step 480 may further include coupling the header 273′ to the hollow body 271′, thereby establishing a housing 270′. The housing 270′ may include an end cover 274′, which may be formed as part of the housing 270′. The end cover 274′ may also be formed as a separate part and coupled to the housing 270′.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

### EXEMPLARY EMBODIMENTS

The following is a list of exemplary embodiments according to the present disclosure.

Embodiment 1 is an electrochemical cell comprising: (a) a coil electrode defining a cylindrical core and extending circumferentially about the cylindrical core, the coil electrode comprising: (i) an anode; (ii) a cathode; (iii) a separator between the anode and the cathode; (iv) an electrolyte between the anode and the cathode; and (v) an outer constraint extending circumferentially about and radially compressing the coil electrode to hold the coil electrode under a radial stack pressure.

Embodiment 2 is the cell of embodiment 1, wherein the coil electrode has an energy density of 300 Wh/l or greater, 400 Wh/l or greater, 500 Wh/l or greater, or 600 Wh/l or greater.

Embodiment 3 is the cell of any one of the preceding embodiments, wherein the outer constraint comprises an extension of the anode or the cathode.

Embodiment 4 is the cell of any one of the preceding embodiments, wherein the anode comprises copper.

Embodiment 5 is the cell of any one of the preceding embodiments, wherein the anode comprises copper foil.

Embodiment 6 is the cell of any one of the preceding embodiments, wherein the outer constraint comprises a cylindrical canister.

Embodiment 7 is the cell of embodiment 6, further comprising an expander plug in the cylindrical coil, wherein the expander plug presses the coil electrode against the cylindrical canister.

Embodiment 8 is the cell of any one of the preceding embodiments, further comprising an expander plug in the cylindrical coil, wherein the expander plug radially presses the coil electrode against the outer constraint.

Embodiment 9 is the cell of any one of the preceding embodiments, further comprising a feedthrough pin electrically coupled to one of the anode or the cathode.

Embodiment 10 is the cell of any one of the preceding embodiments, wherein the stack pressure is at least 0.3 MPa, at least 0.4 MPa, at least 0.5 MPa, at least 0.6 MPa, at least 0.7 MPa, at least 0.8 MPa, at least 0.9 MPa, or at least 1 MPa.

Embodiment 11 is the cell of any one of the preceding embodiments, further comprising a winding core in the cylindrical core.

Embodiment 12 is the cell of embodiment 11, wherein the winding core is fixedly coupled to the anode or the cathode.

Embodiment 13 is the cell of any one of the preceding embodiments, wherein the outer constraint radially fixates the coil electrode.

Embodiment 14 is an electrochemical cell comprising: (a) a winding core defining a longitudinal axis; (b) a staked electrode comprising: a core portion fixedly coupled to the winding core; and a coil portion wound spirally about the winding core; (c) a constraint electrode comprising: a coil portion wound spirally about the winding core and at least a portion of the coil portion of the staked electrode; and a constraint portion extending circumferentially about and radially compressing the coil portion of the constraint electrode and the coil portion of the staked electrode; (d) a separator wound spirally about the winding core between the coil portion of the staked electrode and the coil portion of the constraint electrode; and (e) an electrolyte between the coil portion of the staked electrode and the coil portion of the constraint electrode; wherein the staked electrode and the constraint electrode are of opposite polarities.

Embodiment 15 is the cell of embodiment 14, wherein the staked electrode is an anode.

Embodiment 16 is the cell of any one of embodiments 14 or 15, wherein the staked electrode comprises copper.

Embodiment 17 is the cell of embodiment 14, wherein the constraint electrode is an anode.

Embodiment 18 is the cell of any one of embodiments 14 or 17, wherein the constraint electrode comprises copper.

Embodiment 19 is the cell of any one of embodiments 14-18, wherein the core portion of the staked electrode is formed from a first material and wherein the coil portion of the staked electrode is formed from a second material different from the first material.

Embodiment 20 is the cell of any one of embodiments 14-19, wherein the core portion of the staked electrode is electrically coupled to the coil portion of the staked electrode.

Embodiment 21 is the cell of any one of embodiments 14-20, wherein the constraint portion of the constraint electrode radially fixates the coil portion of the constraint electrode and the coil portion of the staked electrode.

Embodiment 22 is the cell of any one of embodiments 14-21, wherein the cell has an energy density of 300 Wh/l or greater, 400 Wh/l or greater, 500 Wh/l or greater, or 600 Wh/l or greater.

Embodiment 23 is a method of manufacturing an electrochemical cell, the method comprising: (a) inserting a coil electrode into a cylindrical canister comprising an inner surface, the coil electrode defining a tubular void and comprising an anode, a cathode, and a separator between the anode and the cathode, wherein the anode, the cathode, and the separator are wound about the tubular void; (b) inserting the coil electrode into a cylindrical canister; (c) inserting an expander plug into the tubular void to radially compress the coil electrode between the expander plug and the inner surface of the cylindrical canister, thereby applying a radial stack pressure to the coil electrode.

Embodiment 24 is a method of manufacturing an electrochemical cell, the method comprising: (a) winding a coil electrode around a core, the coil electrode comprising an anode, a cathode, and a separator between the anode and the cathode; (b) winding one of the anode or the cathode around the coil electrode, establishing an outer constraint, the outer constraint radially compressing the coil electrode and applying a radial stack pressure thereto.

Embodiment 25 is the method of any one of embodiments 23 or 24, wherein the radial stack pressure is at least 0.3 MPa, at least 0.4 MPa, at least 0.5 MPa, at least 0.6 MPa, at least 0.7 MPa, at least 0.8 MPa, at least 0.9 MPa, or at least 1 MPa.

Embodiment 26 is the method of any one of embodiments 23-25, wherein the electrochemical cell has an energy density of 300 Wh/l or greater, 400 Wh/l or greater, 500 Wh/l or greater, or 600 Wh/l or greater.

Embodiment 27 is the method of any one of embodiments 23-26, further comprising electrically coupling an anode current collector to the anode.

Embodiment 28 is the method of any one of embodiments 23-27, further comprising electrically coupling a cathode current collector to the cathode.

Embodiment 29 is the method of any one of embodiments 23-28, wherein the anode comprises copper.

Embodiment 30 is the method of any one of embodiments 23-29, wherein the anode comprises copper foil.

1. An electrochemical cell comprising:
a coil electrode defining a cylindrical core and extending circumferentially about the cylindrical core, the coil electrode comprising:
an anode;
a cathode;
a separator between the anode and the cathode;
an electrolyte between the anode and the cathode; and
an outer constraint extending circumferentially about and radially compressing the coil electrode to hold the coil electrode under a radial stack pressure.

2. The cell of claim 1, wherein the coil electrode has an energy density of 300 Wh/l or greater, 400 Wh/l or greater, or 500 Wh/l or greater.

3. The cell of claim 1, wherein the outer constraint comprises an extension of the anode or the cathode.

4. The cell of claim 1, wherein the outer constraint comprises a cylindrical canister.

5. The cell of claim 4, further comprising an expander plug in the cylindrical coil, wherein the expander plug presses the coil electrode against the cylindrical canister.

6. The cell of claim 1, wherein the stack pressure is at least 0.5 MPa.

7. The cell of claim 1, further comprising a winding core in the cylindrical core.

8. The cell of claim 7, wherein the winding core is fixedly coupled to the anode or the cathode.

9. An electrochemical cell comprising:
a winding core defining a longitudinal axis;
a staked electrode comprising:
a core portion fixedly coupled to the winding core; and
a coil portion wound spirally about the winding core;
a constraint electrode comprising:
a coil portion wound spirally about the winding core and at least a portion of the coil portion of the staked electrode; and
a constraint portion extending circumferentially about and radially compressing the coil portion of the constraint electrode and the coil portion of the staked electrode;
a separator wound spirally about the winding core between the coil portion of the staked electrode and the coil portion of the constraint electrode; and
an electrolyte between the coil portion of the staked electrode and the coil portion of the constraint electrode;
wherein the staked electrode and the constraint electrode are of opposite polarities.

10. The cell of claim 9, wherein the staked electrode is an anode.

11. The cell of claim 9, wherein the constraint electrode is an anode.

12. The cell of claim 9, wherein the core portion of the staked electrode is formed from a first material and wherein the coil portion of the staked electrode is formed from a second material different from the first material.

13. The cell of claim 9, wherein the constraint portion of the constraint electrode radially fixates the coil portion of the constraint electrode and the coil portion of the staked electrode.

14. A method of manufacturing an electrochemical cell, the method comprising:
inserting a coil electrode into a cylindrical canister comprising an inner surface, the coil electrode defining a tubular void and comprising an anode, a cathode, and a separator between the anode and the cathode, wherein the anode, the cathode, and the separator are wound about the tubular void;
inserting the coil electrode into a cylindrical canister;
inserting an expander plug into the tubular void to radially compress the coil electrode between the expander plug and the inner surface of the cylindrical canister, thereby applying a radial stack pressure to the coil electrode.

15. A method of manufacturing an electrochemical cell, the method comprising:
winding a coil electrode around a core, the coil electrode comprising an anode, a cathode, and a separator between the anode and the cathode;
winding one of the anode or the cathode around the coil electrode, establishing an outer constraint, the outer constraint radially compressing the coil electrode and applying a radial stack pressure thereto.
